(19) United States
(12) Patent Application Publication
(10) Pub. No.: US 2007/0292009 A1
(43) Pub. Date: Dec. 20, 2007

(54) Press/Push USB Flash Drive With Deploying And Retracting Functionalities With Elasticity Material And Fingerprint Verification Capability

(75) Inventors: David Nguyen, San Jose, CA (US); Jim Chin-Nan Ni, San Jose, CA (US); Charles Chung Lee, Cupertino, CA (US); Ming-Shiang Shen, Taipei Hsien (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Super Talent Electronics, Inc., San Jose, CA (US)

(21) Appl. No.: 11/845,747

(22) Filed: Aug. 27, 2007

Related U.S. Application Data
(63) Continuation-in-part of application No. 09/478,720, filed on Jan. 6, 2000, now Pat. No. 7,257,714.
(63) Continuation-in-part of application No. 09/366,976, filed on Aug. 4, 1999, now Pat. No. 6,547,130.
(63) Continuation-in-part of application No. 10/991,313, filed on Nov. 16, 2004.
(63) Continuation-in-part of application No. 11/309,594, filed on Aug. 28, 2006.
(63) Continuation-in-part of application No. 10/707,277, filed on Dec. 2, 2003, now Pat. No. 7,103,684.
(63) Continuation-in-part of application No. 11/309,847, filed on Oct. 12, 2006.

(51) Int. Cl. G06K 9/00

(52) U.S. Cl. 382/124

(57) ABSTRACT

A pen-type computer peripheral device includes an elongated housing containing a PCBA having a plug connector and a fingerprint sensor mounted thereon. The PCBA is secured to a positioning member that is actuated by way of a press-push button that is exposed through a slot defined in a wall of the housing. By pressing and pushing (sliding) the press-push button along the slot, the fingerprint sensor and the plug connector are moved between a retracted position, in which the fingerprint sensor is positioned inside of the housing and the plug connector is covered by a portion of the housing wall, and a deployed position in which the fingerprint sensor is exposed through the slot and the plug connector extends through a front housing opening such that both the fingerprint sensor and the plug connector are exposed outside of the housing.

### RELATED APPLICATIONS

This application is a continuation in part of U.S. patent application for “ELECTRONIC DATA STORAGE MEDIUM WITH FINGERPRINT VERIFICATION CAPABILITY”, U.S. application Ser. No. 09/478,720, filed Jan. 6, 2000, which has been petitioned claiming benefit of Continuation-In-Process status of one of inventor's earlier U.S. patent application for “INTEGRATED CIRCUIT CARD WITH FINGERPRINT VERIFICATION CAPABILITY”, U.S. application Ser. No. 09/366,976, filed Aug. 4, 1999, now issued as U.S. Pat. No. 6,547,130.

This application is also a continuation in part of U.S. patent application for “A METHOD FOR MANUFACTURING A MEMORY DEVICE”, U.S. application Ser. No. 10/991,313, filed Nov. 16, 2004.

This application is also a continuation in part of U.S. patent application for “SINGLE-CHIP MULTI-MEDIA CARD/SECURE DIGITAL (MMC/SD) CONTROLLER READING POWER-ON BOOT CODE FROM INTEGRATED FLASH MEMORY FOR USER STORAGE”, U.S. application Ser. No. 11/309,594, filed Aug. 28, 2006, which is a continuation in part of U.S. patent application for “SINGLE-CHIP USB CONTROLLER READING POWER-ON BOOT CODE FROM INTEGRATED FLASH MEMORY FOR USER STORAGE”, U.S. Pat. No. 7,103,684, filed Dec. 2, 2003.

This application is also a continuation in part of U.S. patent application for “USB Device with Integrated USB Plug with USB-Substrate Supporter Inside”, U.S. application Ser. No. 11/309,847, filed Oct. 12, 2006.

This application relates to U.S. Pat. No. 7,004,780, filed on May 13, 2004, and entitled “PORTABLE COMPUTER PERIPHERAL APPARATUS WITH RETRACTABLE PLUG CONNECTOR”.

### BACKGROUND OF THE INVENTION

1. Field of the Invention

The invention relates to an electronic data storage medium, more particularly to an electronic data storage medium with a fingerprint verification capability and to a standard USB flash drive with deploying and retracting functions using press and push style.

2. Description of the Related Art

In the past, confidential data files were stored in floppy disks or were delivered via networks that require passwords or that use encryption coding for security. Confidential documents can be sent by adding safety seals and impressions during delivering. However, the aforesaid are exposed to the risks of breaking of the passwords, encryption codes, safety seals and impressions, thereby resulting in unsecure transfer of information.

More recently, there is an ongoing trend towards the use of miniaturized, portable computer peripheral devices to store confidential data. In certain cases, such peripheral devices have been reduced to “pocket size”, meaning that they can literally be carried in a user's pocket in the same manner as a wallet or set of keys. One example of particular interest, in which context the present invention will be described herein, is a “flash disk”, or “Universal Serial Bus (USB) flash drive”. For example, one product includes a pen-type flash device having a USB connector plug that can be connected to a USB port of a standard computer. The USB plug connector is protected by a removable cover when not in use. A problem with convention pen-type peripheral devices is that the removable cover can become inadvertently lost while the device is in use, thereby leaving the USB plug connector exposed to damage or contamination.

What is needed is a pen-type portable computer peripheral device that overcomes the problems associated with conventional structures.

### SUMMARY OF THE INVENTION

Therefore, the object of the present invention is to provide a pen-type electronic data storage medium with a fingerprint verification capability for security during the transfer of information.

According to the present invention, an electronic data storage medium is adapted to be accessed by a data terminal. The electronic data storage medium includes a memory device, a fingerprint sensor, an input-output interface circuit and a processing unit. The memory device stores a data file and fingerprint reference data obtained by scanning a fingerprint of a person authorized to access the data file. The fingerprint sensor is adapted to scan a fingerprint of a user of the electronic data storage medium and to generate fingerprint scan data. The input/output interface circuit is activable so as to establish communication with the data terminal. The processing unit is connected to the memory device, the fingerprint sensor and the input/output interface circuit. The processing unit is operable selectively in a programming mode, where the processing unit activates the input/output interface circuit to receive the data file and the fingerprint reference data from the data terminal, and to store the data file and the fingerprint reference data in the memory device, and a data retrieving mode, where the processing unit receives the fingerprint scan data from the fingerprint sensor, compares the fingerprint scan data with the fingerprint reference data in the memory device to verify if the user of the electronic data storage medium is authorized to access the data file stored in the memory device, and activates the input/output interface circuit to transmit the data file to the data terminal upon verifying that the user of the electronic data storage medium is authorized to access the data file stored in the memory device.

The present invention is particularly directed to a “press-and-push” pen-type portable computer peripheral device (apparatus) in which a plug connector (e.g., a USB plug connector) and a fingerprint sensor are manually deployed or retracted inside an elongated housing, for example, by way of a press-push button. The plug connector and the fingerprint sensor are mounted onto a printed circuit board that is fixedly connected to a positioning member that is movably disposed inside an elongate housing, with the press-push button extending from the positioning member through a slot defined in the housing. When a user manually presses and pushes or pulls the press-push button, the user is able to move the plug connector between a retracted position, in which the plug connector is positioned inside of the housing, and a deployed position in which the plug connector extends through the opening and is exposed outside of the housing. In accordance with an aspect of the present invention, when the plug connector is in the retracted position, a portion of the device housing covers the fingerprint sensor, thereby protecting the fingerprint sensor from damage during transportation (i.e., when not in use). Conversely, when the plug connector is moved into the deployed position, the fingerprint sensor is exposed through an opening in the housing wall, thereby facilitating the securing function described above. By maintaining the plug connector in the retracted position and enclosing the fingerprint sensor whenever the peripheral device is disconnected from a host system, the present invention provides a convenient means for protecting the plug connector and the fingerprint sensor from damage and contamination without the need for a removable cap, which can be lost.

In accordance with an aspect of the present invention, the positioning member includes a base portion, a flexible wall disposed on a first side of the base portion, and a pair of slide rails disposed on a second side of the base portion. The press-push button is integrally disposed on and extends from the flexible wall, and the flexible wall is supported by the positioning member in the housing such that when the press-push button is manually pressed into the housing, the slide rails contact and slide along an inside surface of the housing wall, thus allowing the flexible wall to bend or otherwise resiliently deflect into the housing. When the press-push button is subsequently released, the flexible wall resiliently returns the press-push button to its original (raised) position. This resilient bending is utilized to engage and disengage a locking structure (e.g., a locking tab) formed on the flexible wall from corresponding locking structures (e.g., lock grooves) formed on the housing wall. For example, a locking tab extending from the flexible wall is engaged in a retracted lock groove formed on the inside wall of the housing when the plug connector is in the retracted position. To move the plug connector into the deployed position, the press-push button is pressed into the housing, thus detaching the locking tab from the retracted lock groove, and then the press-push button is pushed (slid) toward a front end of the housing, thereby causing the plug connector to emerge from a front opening of the housing. When the plug connector reaches the fully deployed position and the press-push button is released, the flexible wall resiliently returns to its original shape, which causes the locking tab to engage a deployed lock groove, thereby securing the plug connector in the deployed position. Thus, the present invention provides a novel ‘press/push’ mechanism applying mechanical concept based on the elasticity of flexible material such as plastic. The design is quite simple in compared to other styles for a reason, the mechanism of locking or releasing could achieve in linear motion instead of very complicate trajectory paths as in conventional press-push devices.

In accordance with an embodiment of the present invention, a pen-type portable computer peripheral device includes the novel ‘press/push’ mechanism described above, but does not include a fingerprint sensor.

In accordance with another embodiment of the present invention, the plug connector is a “low-profile” plug connector.

### BRIEF DESCRIPTION OF THE DRAWING

Other features and advantages of the present invention will become apparent in the following detailed description of the preferred embodiment with reference to the accompanying drawings, of which:

FIG. 1 is a schematic circuit block diagram illustrating the preferred embodiment of an electronic data storage medium according to the present invention;

FIGS. 2(A) and 2(B) are perspective views showing a pen-type computer peripheral device in alternative closed and open positions, respectively, according to an embodiment of the present invention;

FIG. 3 is an exploded perspective view showing the peripheral device of FIG. 2;

FIGS. 4(A) and 4(B) are bottom perspective views showing an upper housing portion of the peripheral device of FIG. 2;

FIG. 5 is a bottom perspective view showing a positioning member of the peripheral device of FIG. 2;

FIGS. 6(A), 6(B) and 6(C) are exploded perspective views depicting assembly of the peripheral device of FIG. 2;

FIGS. 7(A), 7(B), 7(C) and 7(D) are simplified cross-sectional side views depicting the peripheral device of FIG. 2 during operation;

FIGS. 8(A) and 8(B) are simplified cross-sectional end views depicting the peripheral device of FIG. 2 during operation;

FIGS. 9(A) and 9(B) are simplified cross-sectional modified top views depicting the pen-type computer peripheral device of FIG. 2 during operation;

FIG. 10 is a perspective view showing a pen-type computer peripheral device according to another embodiment of the present invention;

FIG. 11 is an exploded perspective view showing the peripheral device of FIG. 10 in additional detail;

FIG. 12 is a bottom perspective view showing an upper housing portion of the peripheral device of FIG. 10;

FIG. 13 is bottom perspective view showing a positioning member of the peripheral device of FIG. 10;

FIGS. 14(A), 14(B) and 14(C) are exploded perspective views depicting assembly of the peripheral device of FIG. 10;

FIGS. 15(A), 15(B), 15(C) and 15(D) are simplified cross-sectional end views depicting the peripheral device of FIG. 10 during operation;

FIGS. 16(A) and 16(B) are modified top views depicting operation of the pen-type computer peripheral device of FIG. 10;

FIG. 17 is a perspective view showing a pen-type computer peripheral device according to another embodiment of the present invention;

FIG. 18 is a perspective view showing a pen-type computer peripheral device according to another embodiment of the present invention; and

FIGS. 19(A) and 19(B) are perspective views showing a pen-type computer peripheral device according to another embodiment of the present invention.

### DETAILED DESCRIPTION OF THE PREFERRED EMBODIMENT

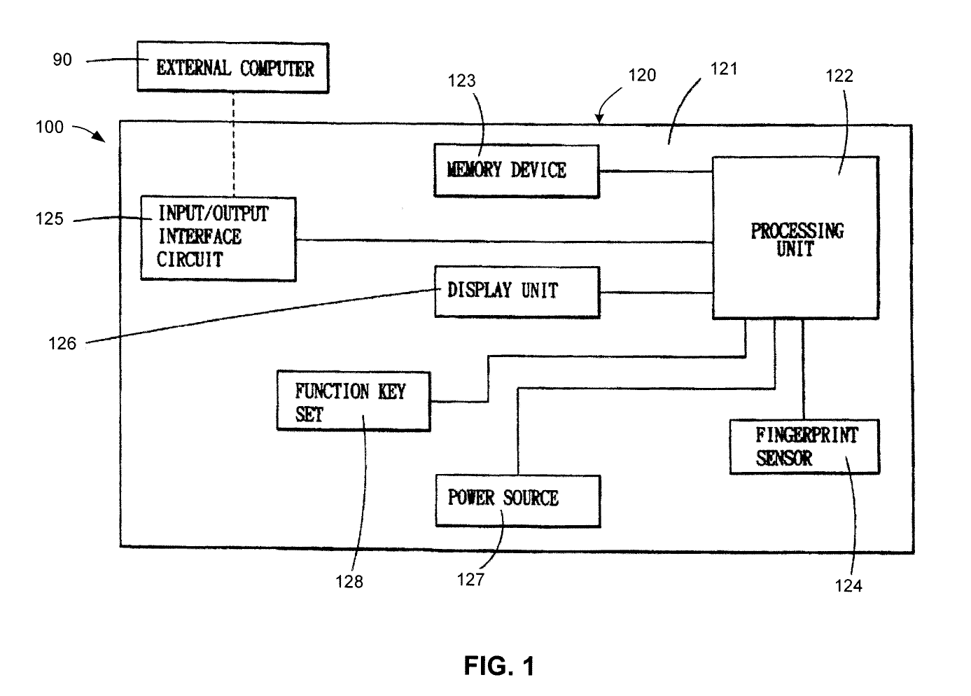

Referring to FIG. 1, according to the preferred embodiment of the present invention, an electronic data storage medium 100 is adapted to be accessed by an external computer 90, and is shown to include a printed circuit board assembly (PCBA) 120 including a card body 121, a processing unit 122, a memory device 123, a fingerprint sensor 124, an input/output interface circuit 125, a display unit 126, a power source 127, and a function key set 128.

The memory device 123, such as a flash memory device, is mounted on the card body 121, and stores a data file, a reference password, and fingerprint reference data obtained by scanning a fingerprint of a person authorized to access the data file in a known manner therein. The data file can be a picture file or a text file.

The fingerprint sensor 124 is mounted on the card body 121, and is adapted to scan a fingerprint of a user of the electronic data storage medium and to generate fingerprint scan data. One example of the fingerprint sensor 124 that can be used in the present invention is that disclosed in a co-owned U.S. Pat. No. 6,547,123, entitled “INTEGRATED CIRCUIT CARD WITH FINGERPRINT VERIFICATION CAPABILITY”, the entire disclosure of which is incorporated herein by reference.

The input/output interface circuit 125, such as a PCMCIA or RS232 interface, is mounted on the card body 121, and is activable so as to establish communication with the external computer 90.

The processing unit 122 is mounted on the card body 121, and is connected to the memory device 123, the fingerprint sensor 124 and the input/output interface circuit 125. The processing unit 122 is operable selectively in:

a programming mode, where the processing unit 122 activates the input/output interface circuit 125 to receive the data file and the fingerprint reference data from the external computer 90, and to store the data file and the fingerprint reference data in the memory device 123 in a compressed format to increase storage capacity of the memory device 123;

a data retrieving mode, where the processing unit 122 receives the fingerprint scan data from the fingerprint sensor 124, compares the fingerprint scan data with at least a segment of the fingerprint reference data in the memory device 123 to verify if the user of the electronic data storage medium is authorized to access the data file stored in the memory device 123, and activates the input/output interface circuit 125 to transmit the data file to the external computer 90 upon verifying that the user of the electronic data storage medium is authorized to access the data file stored in the memory device 123; and

a data resetting mode, where the data file and the finger reference data are erased from the memory device 123.

The power source 127 is mounted on the card body 121, and is connected to the processing unit 122 for supplying electrical power thereto.

The function key set 128, which is mounted on the card body 121, is connected to the processing unit 122, and is operable so as to initiate operation of the processing unit 122 in a selected one of the programming, data retrieving and data resetting modes. The function key set 128 is operable to provide an input password to the processing unit 122. The processing unit 122 compares the input password with the reference password in the memory device 123, and initiates operation in the data resetting mode upon verifying that the input password corresponds with the reference password.

The display unit 126 is mounted on the card body 121, and is connected to and controlled by the processing unit 122 for showing the data file exchanged with the external computer 90 and the operating status of the electronic data storage medium thereon.

Preferably, the processing unit 122 automatically initiates operation in the data resetting mode upon detecting that a preset time period has elapsed since storage of the data file and the fingerprint reference data in the memory device 123.

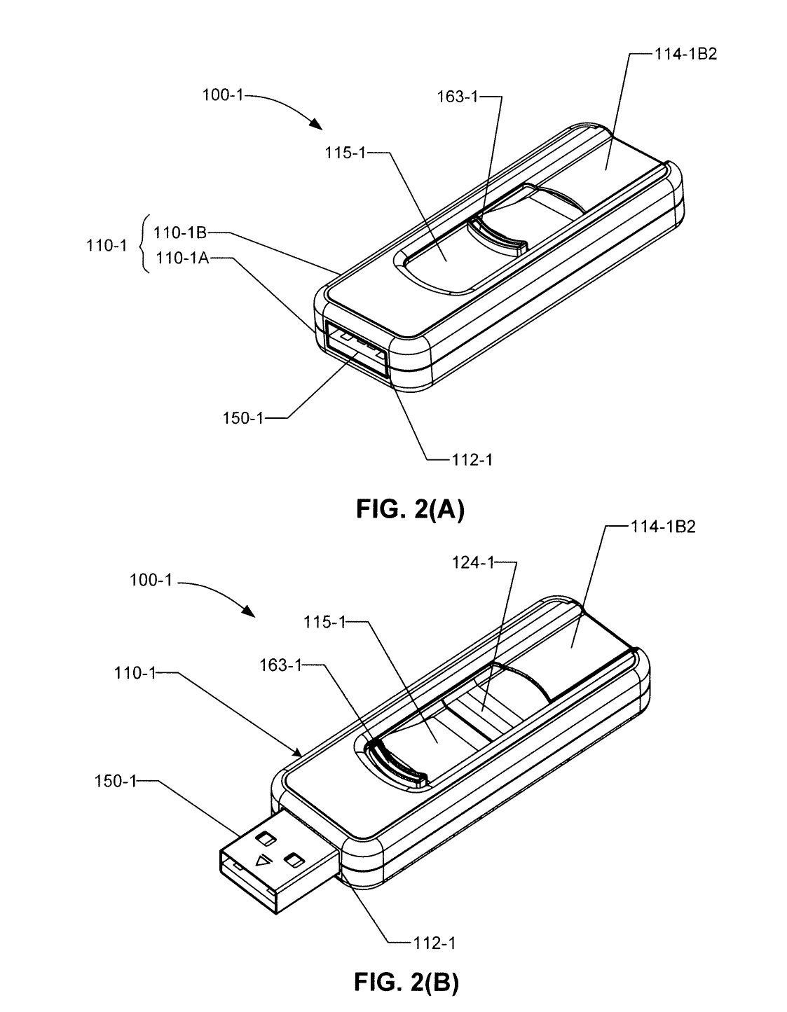

As set forth in the specific embodiments below, the present invention is directed to pocket-sized, press-push, pen-type (i.e., retractable) portable computer peripheral devices that are connected by plug connectors to host computer systems (e.g., computer 90; see FIG. 1) to perform the programming, data retrieving and data resetting functions described above. In particular, as described below with reference to the embodiments shown in FIGS. 2-16, the present invention is directed to peripheral devices in which both the plug connector and fingerprint sensor 124 (FIG. 1) are selectively retracted or otherwise protected inside a housing when not in use, and selectively deployed (i.e., exposed outside of the housing 110-1) when in use.

FIGS. 2(A) and 2(B) show a pocket-sized, pen-type (i.e., retractable) portable computer peripheral device 100-1 having a Universal Serial Bus (USB) plug connector 150-1 and a fingerprint detector 124-1 according to a first specific embodiment of the present invention. As shown in FIG. 2(A), in a fully retracted position, USB plug connector 150-1 is retracted through a front opening 112-1 defined by elongated housing 110-1, and the fingerprint sensor (not shown) is protectively covered (hidden) by a rear upper wall portion 114-1B2. A press-push button 163-1 is integrally connected to a positioning member (not shown, described below) and is partially exposed through a slot 115-1 to facilitate manual movement between the fully retracted (first) position shown in FIG. 2(A), and a fully deployed (second) position shown in FIG. 2(B). To deploy USB plug connector 150-1 for use, a user manually presses press-push button 163-1 into housing 110-1 (i.e., in the direction P indicated by dark arrow in FIG. 2(A)), and then pushes (slides) button 163-1 along slot 115-1 toward the front end of housing 110-1 (i.e., in the direction of arrow S in FIG. 2(A)). This press-push operation causes plug connector 150-1 to emerge from front opening 112-1. As shown in FIG. 2(B), when fully deployed for use, plug connector 150-1 extends from front opening 112-1 of housing 110-1, and fingerprint sensor 124-1 is moved forward from under rear upper wall portion 114-1B2 such that it is exposed in slot 115-1. When plug connector 150-1 and fingerprint sensor 124-1 are deployed/exposed outside housing 110-1, peripheral device 100-1 can be plugged into a host computer and function in the programming, data retrieving, and data resetting modes described above. Once the desired operations are completed, plug connector 150-1 and fingerprint sensor 124-1 are retracted into housing 110-1 by pressing press-push button 163-1, and pulling press-push button 163-1 backward along slot 115-1 (i.e., in the direction opposite to arrow S in FIG. 2(A)).

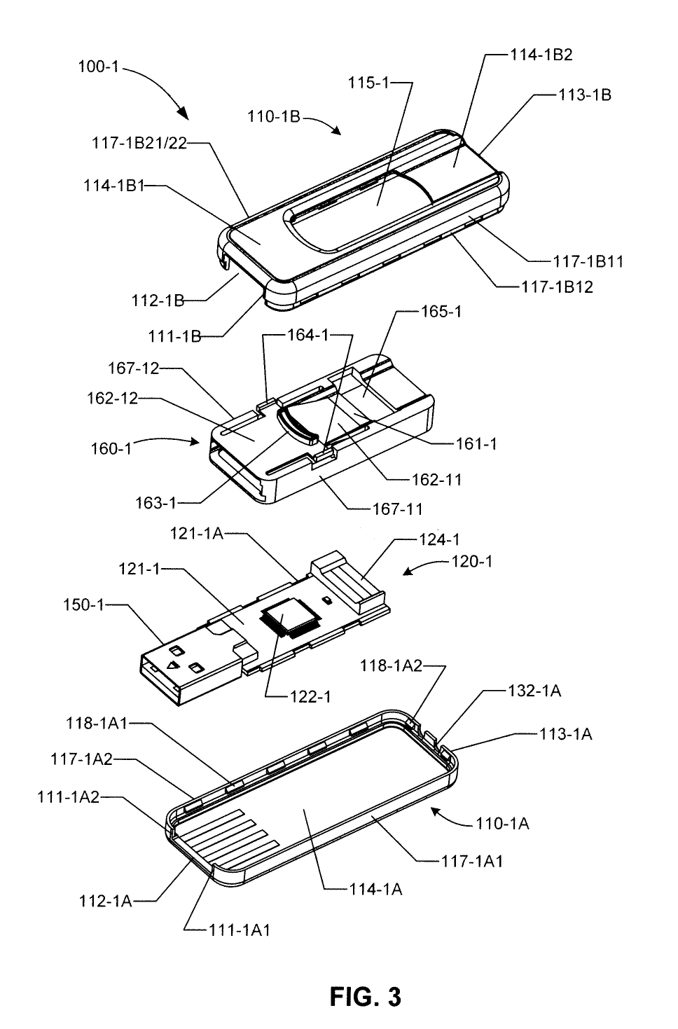

FIG. 3 is an exploded perspective view showing device 100-1 in additional detail. Device 100-1 generally includes a rectangular two-part housing 110-1, a printed circuit board assembly (PCBA) 120-1 that is mounted inside of housing 110-1, and a manual (press-slide) positioning member 160-1 mounted on PCBA 120-1.

Referring briefly to FIG. 2(A), two-part molded plastic housing 110-1 includes a lower (first) portion 110-1A and an upper (second) portion 110-1B.

As shown at the bottom of FIG. 3, lower portion 110-1A includes a lower wall 114-1A, first side wall portions 117-1A1 and 117-1A2, a rear wall portion 113-1A, and front wall portions 111-1A1 and 111-1A2 defining a front opening portion 112-1A. Connecting tabs 118-1A1 protrude from inside surfaces of side walls 117-1A1 and 117-1A2, and connection tabs 118-1A2 are defined from inside surface of rear wall portion 113-1A. Rear wall 113-1A includes key-chain slots 132-1A.

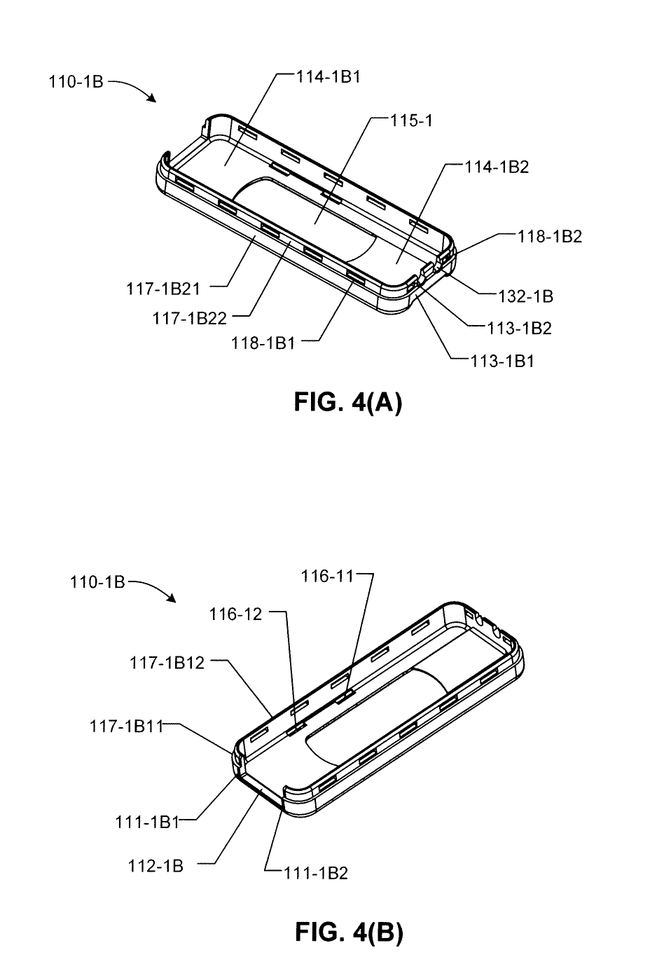

As shown at the top of FIG. 3 and in FIG. 4, upper portion 110-1B includes a relatively wide, elongated upper wall that is divided into a front upper wall portion 114-1B1 and a rear upper wall portion 114-1B2 that are separated by a slot (finger print area cut-out) 115-1. Extending downward from the upper wall are two-part side walls including outer side walls 117-1B11 and 117-1B21 and inner walls 117-1B12 and 117-1B22, front wall portions 111-1B1 and 111-1B2 that define front opening portion 112-1B, and a rear outer wall 113-1B1. Connecting slots 118-1B1 are defined through inner side walls 117-1B12 and 117-1B22. A pair of locking slots 118-1B2 is defined through rear inner wall 113-1B2. Retracted lock grooves (second locking structures) 116-11 and deployed lock grooves (third locking structures) 116-12 are defined in an inside surface of front upper wall portion 114-1B1. Rear inner wall 113-1B2 includes key-chain protrusions 132-1B. 132-1A and 132-1B combination during the assembly process provide key-chain holes.

Referring to the center of FIG. 3, PCBA 120-1 includes a printed circuit board (PCB or card) 121-1 and a USB metal connector 150-1 that is attached to a front end of PCB 121-1 using known techniques such that PCB 121-1 is approximately aligned centered to USB metal connector 150-1. As discussed above, PCB 121-1 includes several ICs (e.g., a controller or processing unit 122-1) disposed thereon, and in the present embodiment includes a fingerprint sensor 124-1 disposed at a rear edge of PCB 121-1. The ICs and fingerprint sensor 124-1 are electronically connected together using known techniques. Cut-out clearances 121-1A are defined in side edges of PCB 121-1 for connected to positioning member 160-1, as described below.

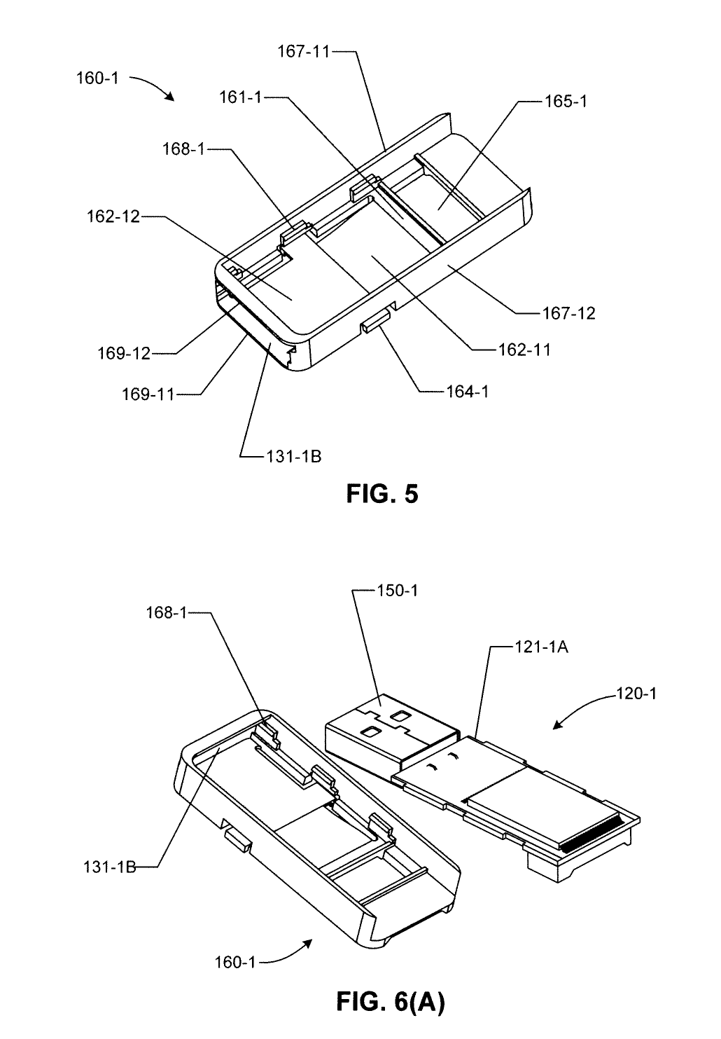

Referring to the center of FIG. 3 and to FIG. 5, positioning member 160-1 includes a base portion 161-1, flexible walls 162-12/162-11 to base portion 161-1 such that flexible wall is resiliently bendable relative to base portion 161-1 in the manner described below. Press-push button 163-1 extends upward from flat flexible wall 162-12 and is disposed adjacent to flat flexible wall 162-12 and slant flexible wall 162-11. Locking tabs (first locking structures) 164-1 also extend upward from flat flexible surface 162-12 and are disposed adjacent to flat flexible wall 162-12 and slant flexible wall 162-11. Base portion 161-1 defines a sensor opening 165-1 whose purpose is described below. Referring to FIG. 5, first and second slide rails 167-11 and 167-12 are fixedly connected to and extend substantially perpendicular to base portion 161-1. Connection tabs 168-1 are fixedly connected to slide rails 167-11 and 167-12 or base portion 161-1, and are positioned to snap-couple onto PCB 121-1 such that each connection tab 168-1 extends into an associated one of cut-outs 121-1A (see FIG. 3). Front walls 169-11 and 169-2 define front opening portion 131-1B.

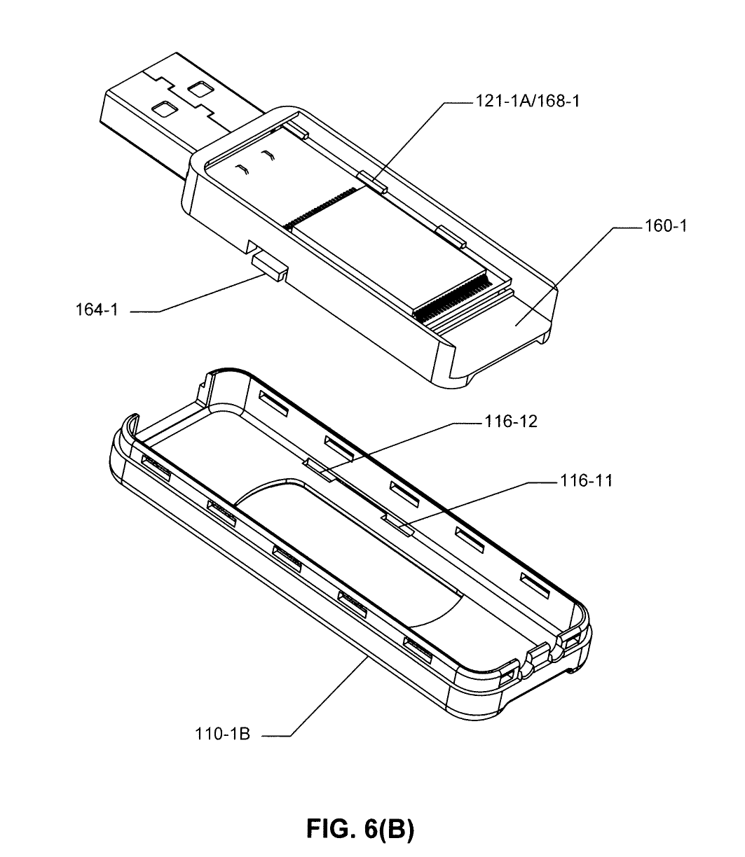

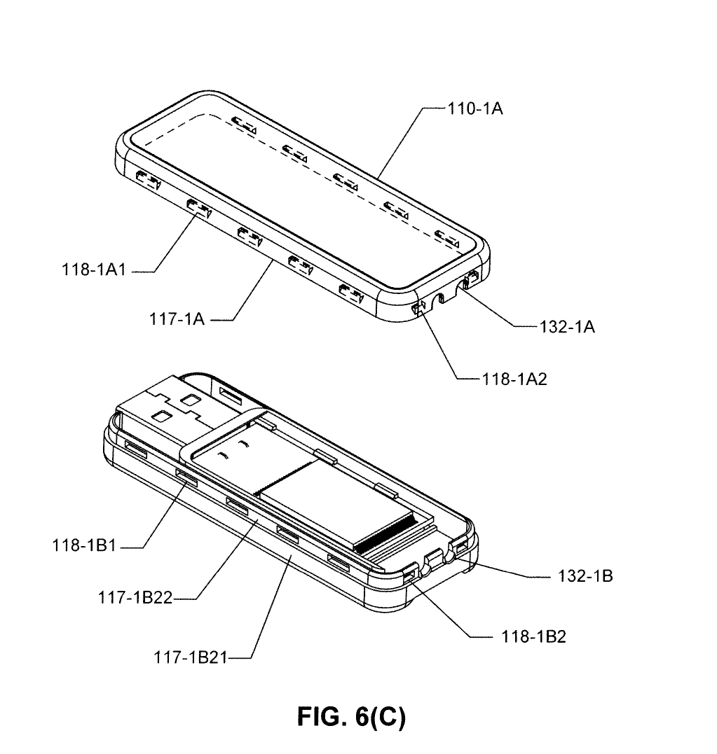

FIGS. 6(A) to 6(C) illustrate assembly of peripheral device 100-1. As shown in FIG. 6(A), PCBA 120-1 is mounted onto positioning member 160-1 with plug connector 150-1 slid through front opening portion 131-1B, next cut-out clearances 121-1A aligned with locking tabs 168-1, and then PCBA 120-1 is pressed downward until locking tabs 168-1 snap into cut-out clearances 121-1A (as shown in FIG. 6(B)). Next, as shown in FIG. 6(B), positioning member 160-1 is mounted into upper housing portion 110-1B so that locking tabs 164-1 are received in retracted position locking grooves 116-11 (as shown in FIG. 6(C)). Although not shown, a portion of the press-push button (which extends downward from flat flexible wall 162-12) is received in slot 115-1. Finally, as shown in FIG. 6(C), the side walls (e.g., side wall 117-1A) of lower housing portion 110-1A are aligned to be received between corresponding side walls (e.g., side walls 117-1B21 and 117-1B22) of upper housing portion 110-1B, and lower housing portion 110-1A is then pressed against upper housing portion 110-1B until locking tabs 118-1A1 are snapped into slots 118-1B1, and locking tabs 118-1A2 are snapped into slots 118-1B2. Note that key-chain slots 132-1A fit in key-chain protrusions 132-1B forming key-chain holes after assembly. In an alternative embodiment, ultrasonic welding may be used in place of the snap-coupling mechanism described above to secure housing portions 110-1A and 110-1B.

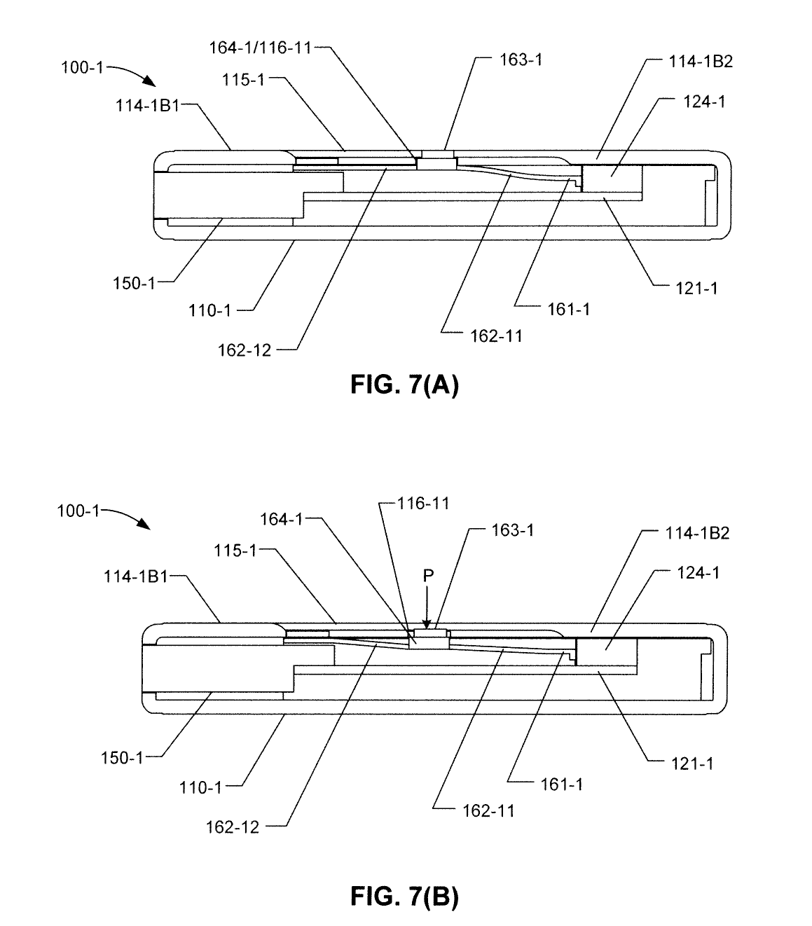

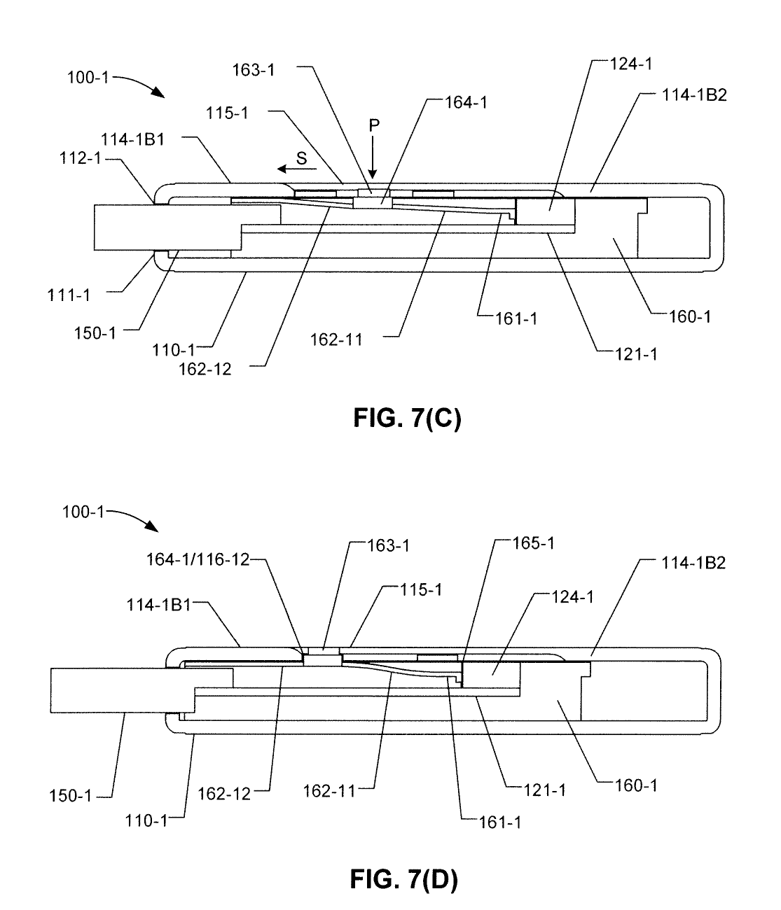

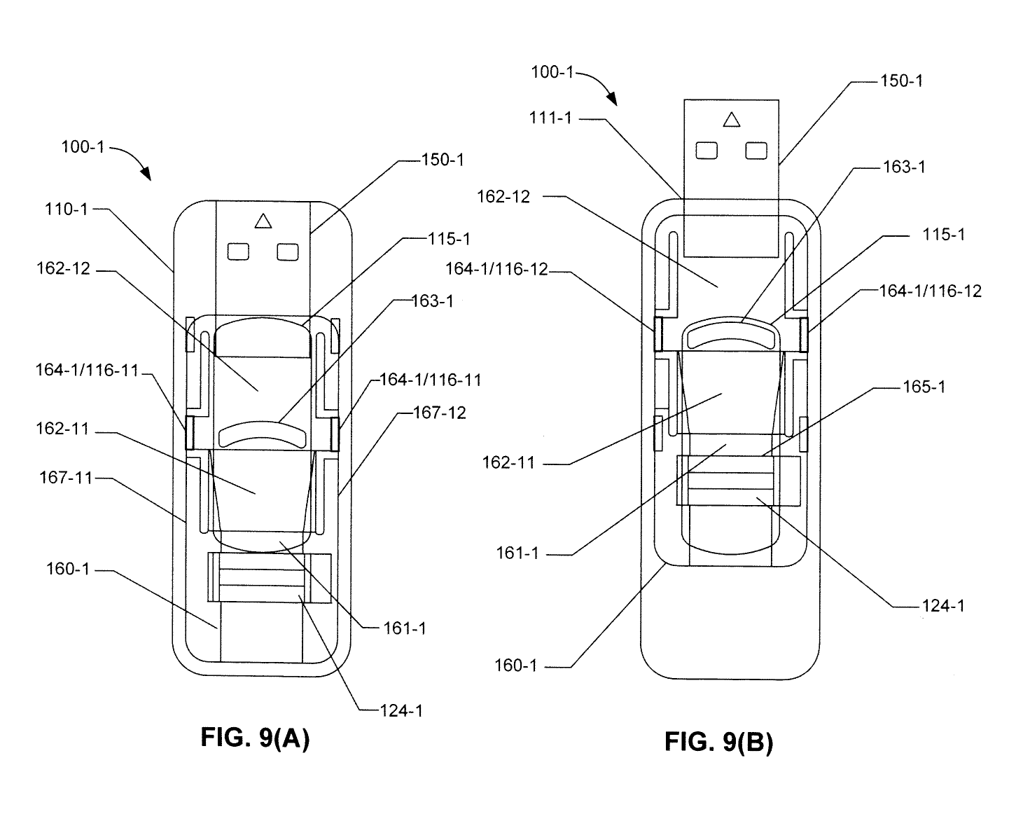

FIGS. 7(A), 8(A) and 9(A) are simplified cross-sectional side, front and top views, respectively, showing portions of peripheral device 100-1 in the retracted state (i.e., with plug connector 150-1 disposed inside housing 110-1). FIGS. 7(A) and 9(A) show that press-push button 163-1 extends upward from flat flexible wall 162-12 through slot 115-1, and sensor 124-1 is covered by upper wall portion 114-1B2. In addition, as indicated in each of FIGS. 7(A), 8(A) and 9(A), in the retracted position, locking tabs 164-1 are biased into retracted locking grooves 116-11, which are defined in upper wall portion 114-1B1, thereby preventing movement of positioning member 160-1 and PCB 121-1 within housing 110-1.

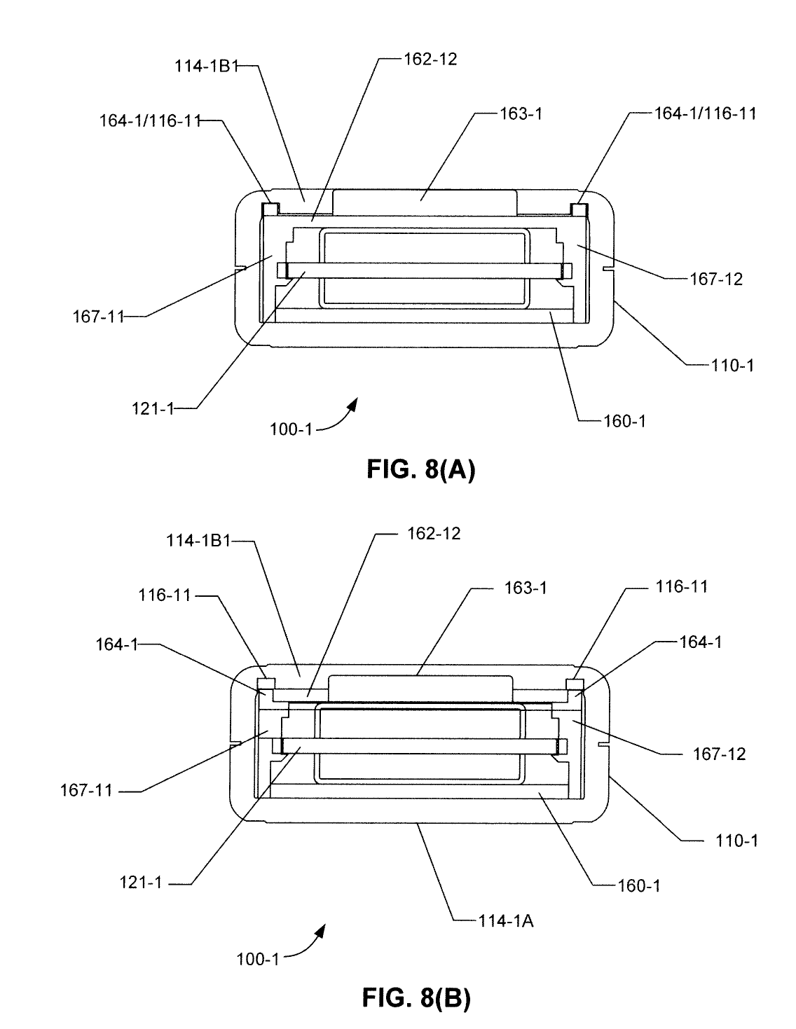

The press-push operation performed to deploy plug connector 150-1 is now described with reference to FIGS. 7(B), 7(C) and 8(B). First, a downward pressing force P is applied press-push button 163-1 (as indicated by dark arrow in FIG. 7(B)). Pressing force P causes flat flexible wall 162-12 and slant flexible wall 162-11 to bend relative to base portion 161-1 such that locking tabs 164-1 are disengaged from locking grooves 116-11 and moved away from upper wall portion 114-1B1. Referring to FIG. 8(B), the pressing force applied to the press-push button pushes slide rails 167-11 and 167-12 against an inside surface of lower housing wall 114-1A, which in turn applies resisting forces R against slide rails 167-11 and 167-2, thereby facilitating the bending of flat flexible wall 162-12 and slant flexible wall 162-11 away from upper wall portion 114-1B1. Referring to FIG. 7(C), while maintaining pressing force P, a pushing force S is also applied to press-push button 163-1, causing positioning member 160-1 and PCB 121-1 to move forward in housing 110-1 such that plug connector 150-1 begins to protrude through front opening 112-1 defined by front wall 111-1. Referring again to FIG. 8(B), note that slide rails 167-11 and 167-12 facilitate this forward movement by presenting a small resistance area on lower housing wall 114-1A. Note also that, because the pressing force P applied to press-push button 163-1 is applied to lower wall 114-1A by way of slide rails 167-11 and 167-12, and because PCB 121-1 is supported by positioning structure (i.e., instead of being supported along the PCB edges in a groove formed in housing 110-1), none of the pressing force is applied to PCB 121-1, thereby providing reliable and durable operation of peripheral device 100-1.

FIGS. 7(D) and 9(B) show peripheral device 100-1 at the end of the press-push operation, when plug connector 150-1 is in the fully deployed position outside of housing 110-1 and locking tabs 164-1 are engaged locking grooves 116-12. Note that, with the pressing force released, flat flexible wall 162-12 and slant flexible wall 162-11 resiliently bias locking tabs 164-1 upward, causing locking tabs 164-1 to engage locking grooves 116-12. In the deployed position, fingerprint sensor 124-1 is exposed through slot 115-1 and sensor opening 165-1 to perform the fingerprint sensing operation described above.

To return peripheral device to the retracted position, press-push button 163-1 is pressed to pop locking tabs 164-1 out of deployed lock groove 116-12, and then button 163-1 is pulled/pushed backward along slot 115-1 until locking tabs 164-1 snap into retracted lock grooves 116-11.

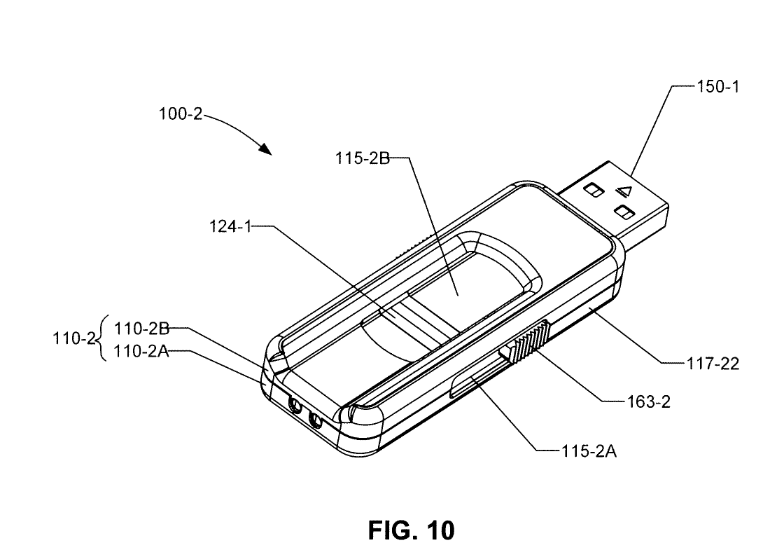

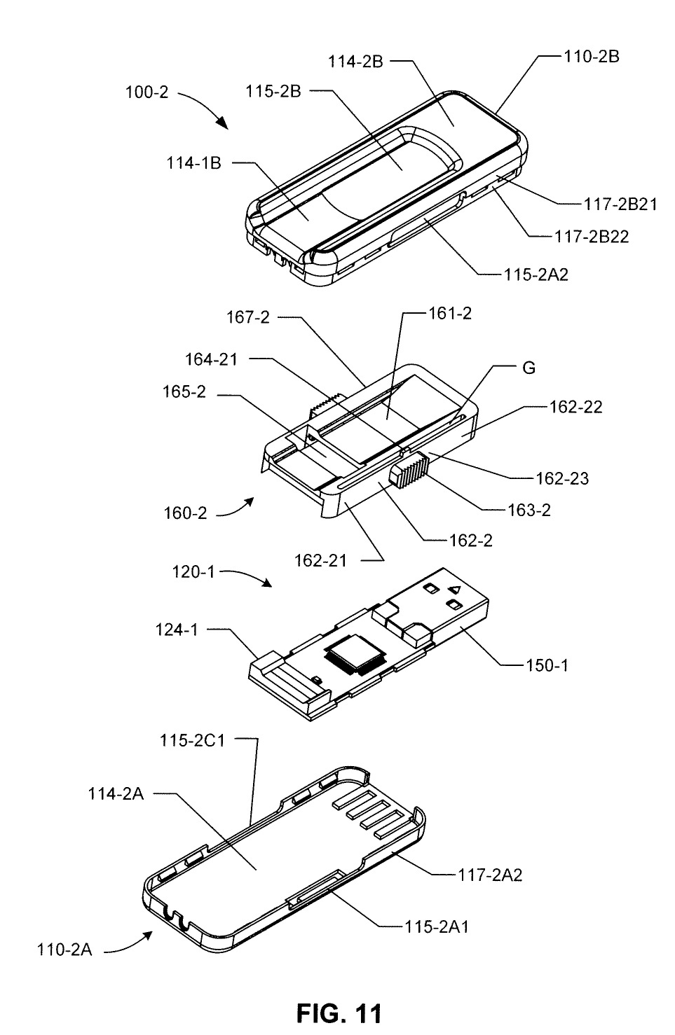

FIGS. 10 and 11 are assembled and exploded perspective views showing a peripheral device 100-2 according to an alternative embodiment of the invention in which a press/push button 163-2 protrudes through a first slot 115-2A located on a side wall 117-22 of a housing 110-2, instead of through an upper housing wall as in the embodiment described above. Press/push button 163-2 is utilized in a manner similar to that described above to deploy and retract USB plug connector 150-1 from housing 110-2. In addition, as in the previous embodiment, a fingerprint sensor 124-1 is exposed through a slot 115-2B.

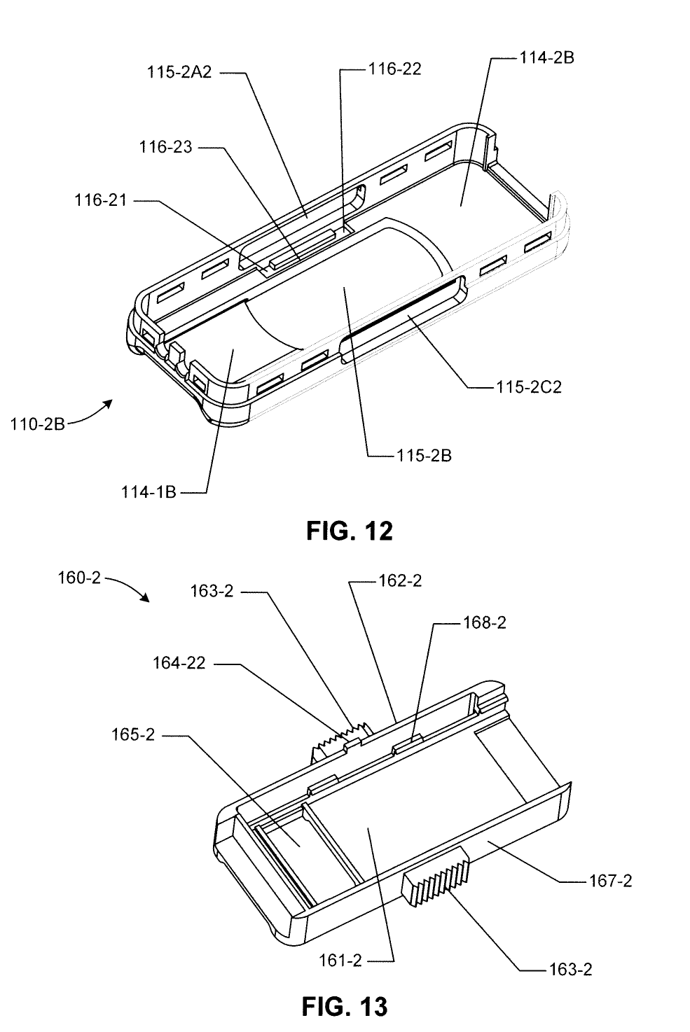

Referring to FIG. 11, device 100-2 generally includes a rectangular two-part housing 110-2, PCBA 120-1 that is described above, a positioning member 160-2 mounted on PCBA 120-1. Two-part molded plastic housing 110-2 includes a lower (first) portion 110-2A and an upper (second) portion 110-2B that are similar to the housing portions described above, but each includes slot portions that combine to provide slots 115-2A and 115-2C. In particular, lower housing portion 110-2A includes a slot portion 115-2A1 defined in side wall portions 117-2A2, and upper housing portion 110-2B includes a slot portion 115-2A2 defined in outer side wall portion 117-2B21 and inner side wall portion 117-2B22. When housing portions 110-2A and 110-2B are assembled, as shown in FIG. 10, side wall portions 117-2A2, 117-2B21 and 117-2B22 combine in a manner similar to that described above to form side wall 117-22, and slot portions 115-2A1 and 115-2A2 combine to form slot 115-2A. As shown in FIG. 12, disposed adjacent to slot portion 115-2A2 on wall 114-2B of upper portion 110-1B are a retracted lock groove (second locking structure) 116-21 and a deployed lock groove (third locking structure) 116-22 that are connected by an intermediate groove 116-23. Substantially identical lock grooves are defined in side wall 114-2A of lower housing portion 110-2A as shown in FIG. 11.

Referring to the center of FIG. 11 and to FIG. 13, positioning member 160-2 includes a flange-like base portion 161-2, a flexible wall 162-2 disposed along one side of base portion 161-2, and slide rail 167-2 extending from a second (opposing) side of base portion 161-2. Flexible wall 162-2 includes opposing first and second ends 162-21 and 162-22 that are integrally connected to base portion 161-2 such that standoff gap G is defined between a central portion 162-23 of flexible wall 162-2 and base portion 161-2. A press-push button 163-2 is disposed adjacent to central portion 162-23 of flexible wall 162-2, and extends upward from flexible wall 162-2. First and second locking tabs 164-21 and 164-22 extend from flexible wall 162-2 on opposite sides of press-push button 163-2. Base portion 161-2 defines a sensor opening 165-2 that functions in a manner similar to that of opening 165-1 (described above). As shown in FIG. 13, connection tabs 168-2 are fixedly connected to base portion 161-2 and function in a manner similar to that described above to snap-couple onto and hold PCB 121-1. A press-push button 163-2 extends upward from slide rail 167-2.

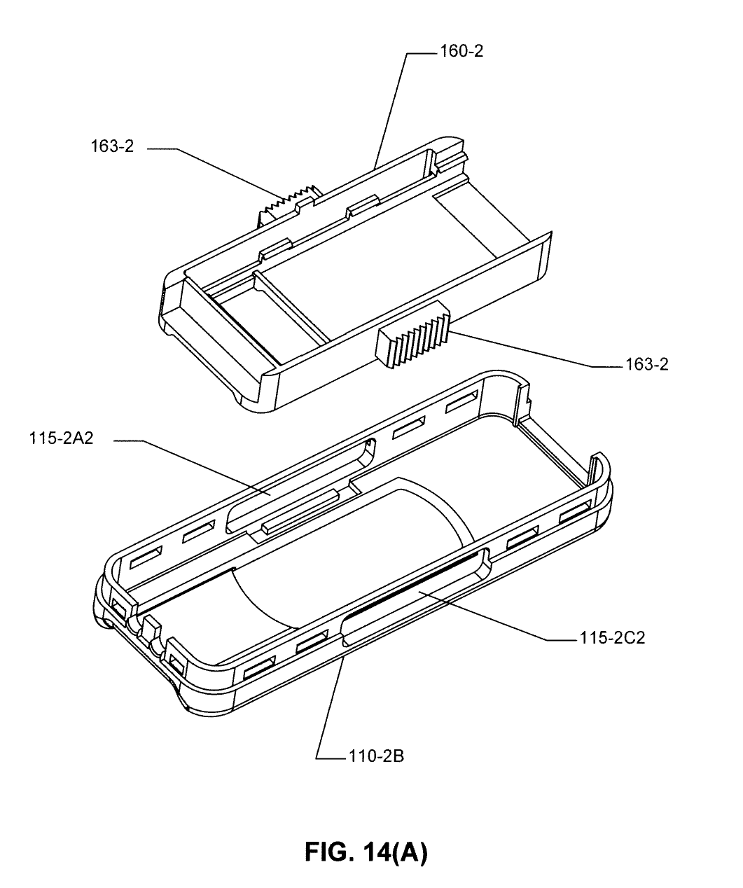

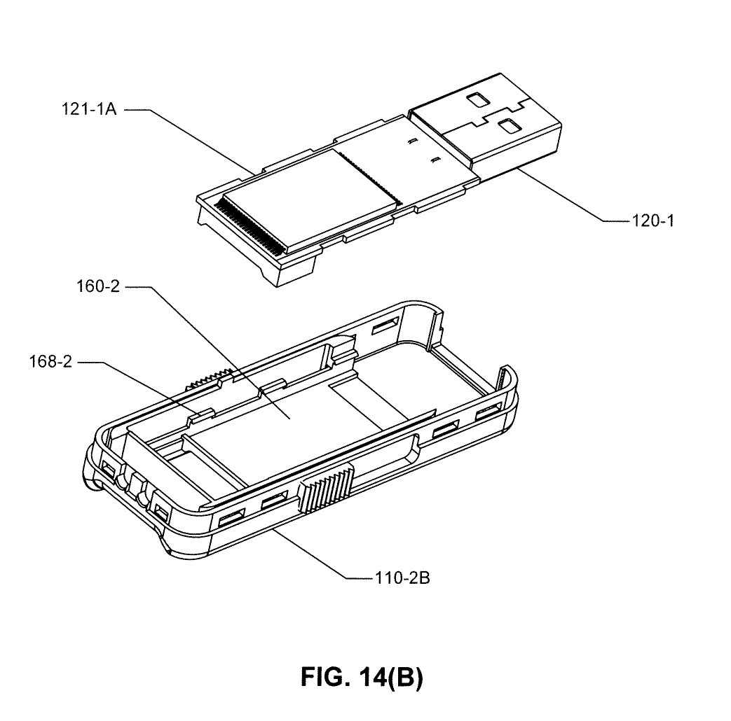

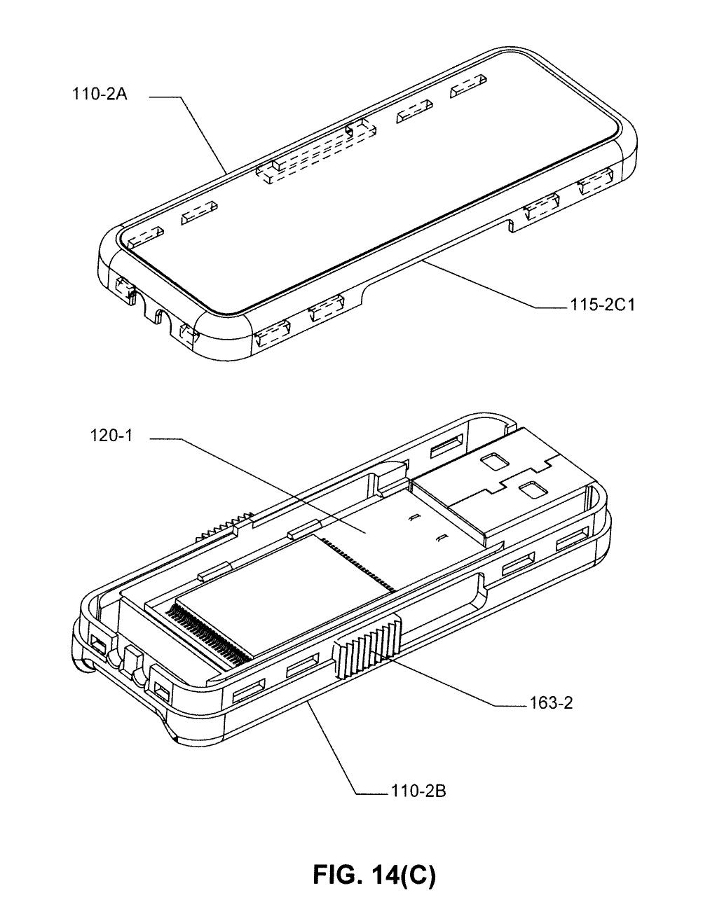

FIGS. 14(A) to 14(C) illustrate assembly of peripheral device 100-2. As shown in FIG. 14(A), positioning member 160-2 is mounted into upper housing portion 110-2B such that a portion of press-push buttons 163-2 is received in slot portions 115-2A2 and 115-2C2. Next, as shown in FIG. 14(B), PCBA 120-1 is mounted onto positioning member 160-2 with cut-out clearances 121-1A aligned with locking tabs 168-2, and then PCBA 120-1 is pressed downward until locking tabs snap into cut-out clearances 121-1A. Finally, as shown in FIG. 14(C), lower housing portion 110-2A is aligned with upper housing portion 110-2B such that press-push button 163-2 is received in slot portion 115-2C1, and lower housing portion 110-2A is then pressed against upper housing portion 110-2B until snap-coupling occurs in the manner described above.

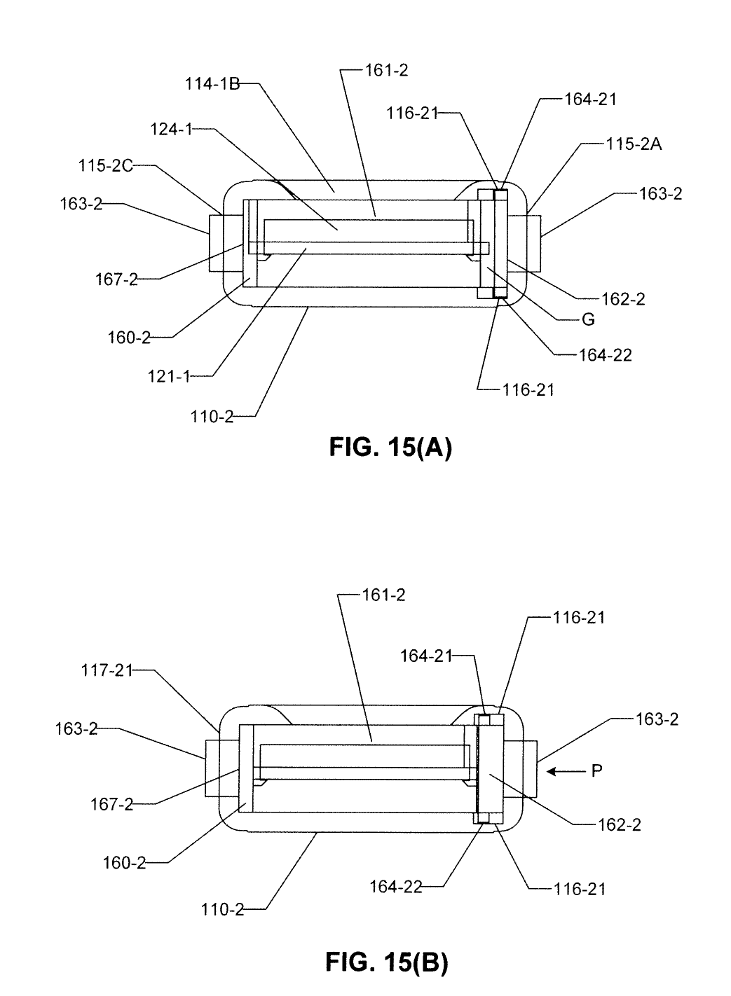

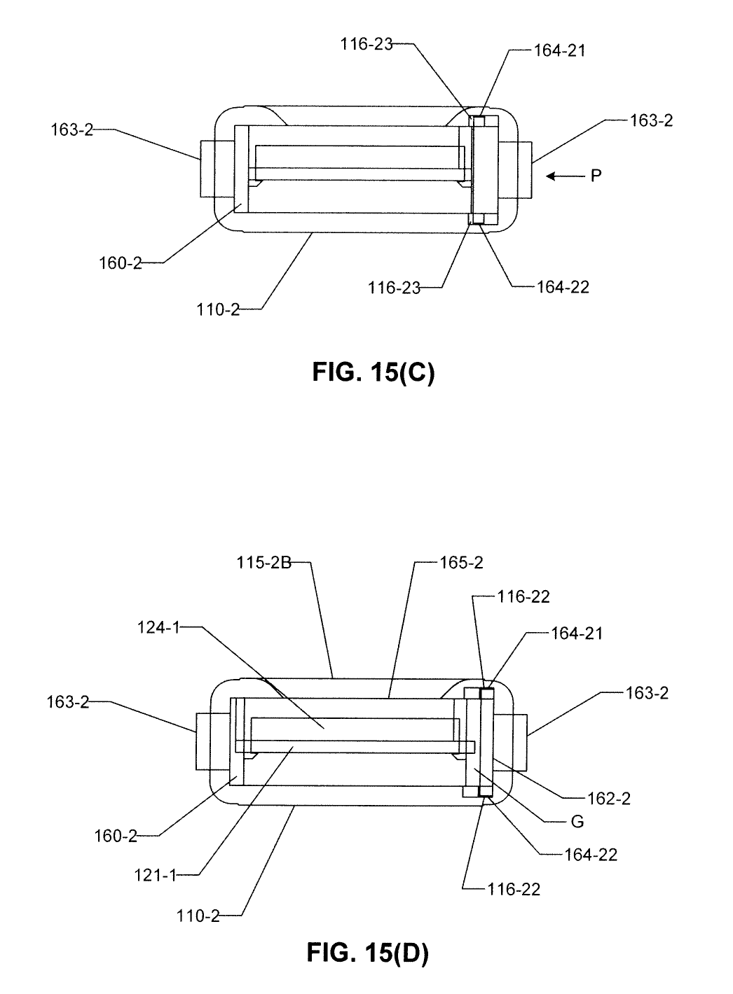

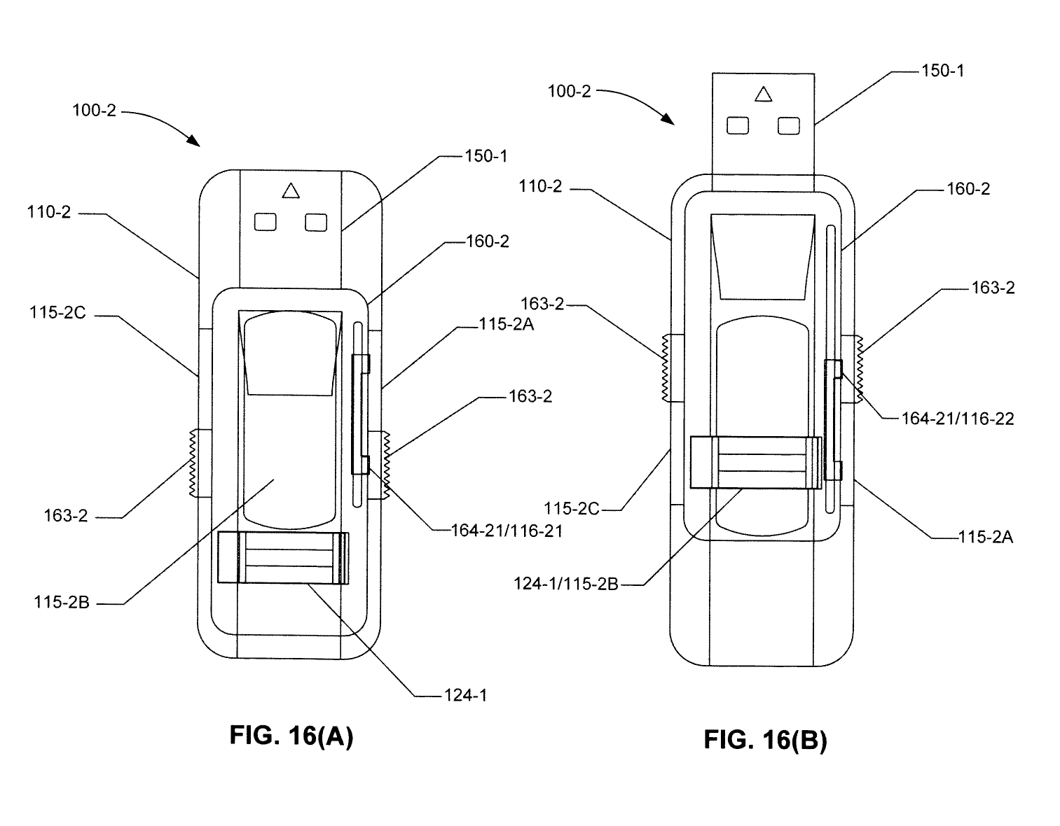

FIGS. 15(A) and 16(A) are simplified cross-sectional end and top views, respectively, showing portions of peripheral device 100-2 in the retracted state (i.e., with plug connector 150-1 disposed inside housing 110-2, as shown in FIG. 16(A)). FIG. 15(A) shows positioning member 160-2 holding PCB 121-1 inside housing 110-2 such that sensor 124-1 is covered by wall portion 114-1B. Flexible wall 162-2 is biased away from base portion 161-2 such that gap G is defined between the two structures. In this state, press-push button 163-2 extends upward from flexible wall 162-2 through slot 115-2A and from slide rail 167-2 through slot 115-2C, and locking tabs 164-21 and 164-22 are respectively engaged in retracted locking grooves 116-21, thereby preventing movement of positioning member 160-2 and PCB 121-1 within housing 110-2.

To deploy plug connector 150-1 a downward pressing force P is applied press-push button 163-2 (as indicated by dark arrow in FIG. 15(B)). Pressing force P causes the central portion of flexible wall 162-2 to bend toward base portion 161-2 such that locking tabs 164-21 and 164-22 are moved to lower regions of locking grooves 116-21. Similar to the previous embodiment, the pressing force applied to press-push button 163-2 pushes slide rail 167-2 against an inside surface of side housing wall 117-21, which in turn applies resisting forces R against slide rail 167-2, thereby facilitating the bending of flexible wall 162-2. Referring to FIG. 15(C), while maintaining pressing force P, a pushing force is applied to press-push button 163-2, causing positioning member 160-2 and PCB 121-1 to move forward in housing 110-2 (e.g., out of the sheet) such that plug connector 150-1 begins to protrude through front opening of housing 110-2 as locking tabs 164-21 and 164-22 move forward in intermediate groove 116-23. As in the previous embodiment, slide rail 167-2 facilitates this forward movement by presenting a small resistance area on side housing wall 117-21. Note also that, because the pressing force applied to press-push button 163-2 is transferred to side housing wall 117-21 by way of slide rail 167-2, and because PCB 121-1 is supported by positioning structure 160-2, none of the pressing force is applied to PCB 121-1, thereby providing reliable and durable operation of peripheral device 100-2.

FIGS. 15(D) and 16(B) show peripheral device 100-2 at the end of the press-push operation, when plug connector 150-1 is in the fully deployed position outside of housing 110-2 and locking tabs 164-21 and 164-22 are respectively engaged in deployed locking grooves 116-22. Note that, with the pressing force released, flexible wall 162-2 resiliently biases locking tabs 164-21 and 164-22. In the deployed position, fingerprint sensor 124-1 is exposed through slot 115-2B and sensor opening 165-2 to perform the fingerprint sensing operation described above.

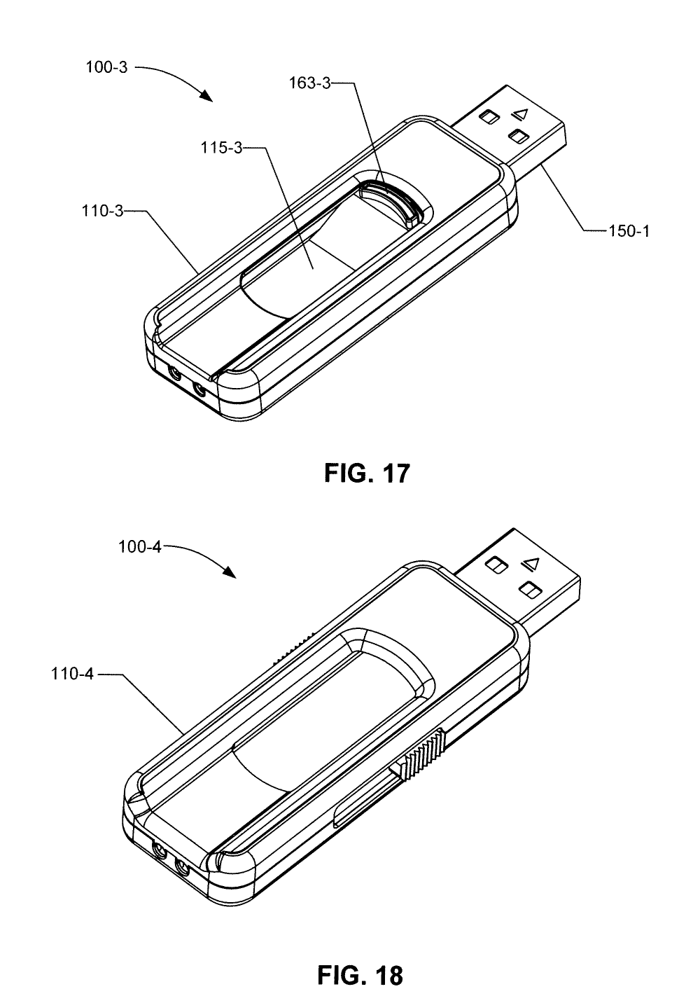

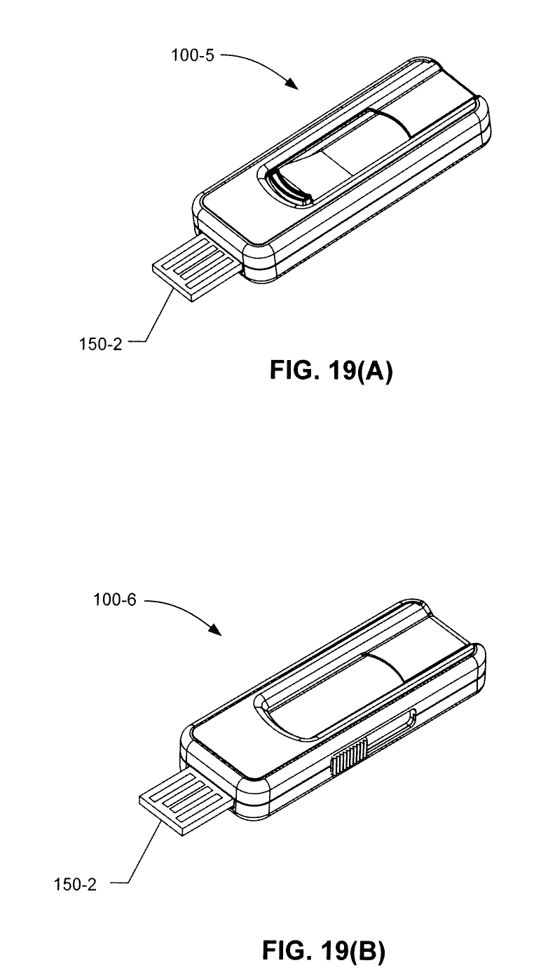

Although the present invention is described above with reference to pen-type computer peripheral devices that include fingerprint sensors and standard USB plug connectors, various novel aspects of the present invention may be utilized in pen-type computer peripheral devices that omit the fingerprint sensors. For example, FIG. 17 shows a peripheral device 100-3 that includes a housing 110-3 containing a positioning member similar to positioning member 160-1 (described above with reference to FIGS. 2-9), but the associated PCBA omits fingerprint sensor 124-1. That is, when press-push button 163-3 and plug connector 150-1 are in the deployed position in housing 110-3, no fingerprint sensor is exposed through slot 115-3. Similarly, FIG. 18 shows a peripheral device 100-4 that includes a housing 110-4 containing a positioning member similar to positioning member 160-2 (described above with reference to FIGS. 10-16), but housing 110-3 omits an opening for exposing s fingerprint sensor. In yet another alternative embodiment, as indicated in FIGS. 19(A) and 19(B), peripheral devices 100-5 and 100-6 include any of the standard housing and positioning member arrangements (e.g., the housing and positioning member of the embodiments described above), but the PCBA utilizes a non-standard plug connector 150-2, such as that disclosed in co-owned and co-pending U.S. patent application Ser. No. 11/112,501, entitled “Low-Profile USB Device”, which is incorporated herein by reference in its entirety. The PCBA with non-standard plug connector 150-2 in this embodiment could either called single-chip USB using COB and molding process to form a package in rectangular shape as connector or slim USB with plastic frame holds PCB substrate inside as connector.

As used herein, directional terms such as “upper”, “upwards”, “lower”, “downward”, “front”, “rear”, are intended to provide relative positions for purposes of description, and are not intended to designate an absolute frame of reference. In addition, the phrases “integrally connected” and “integrally molded” is used herein to describe the connective relationship between two portions of a single molded or machined structure, and are distinguished from the terms “connected” or “coupled” (without the modifier “integrally”), which indicates two separate structures that are joined by way of, for example, adhesive, fastener, clip, or movable joint. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The following are some of the advantages of the present invention:

The electronic data storage medium has a small volume but a large storage capability in a compressed format, thereby resulting in convenience during data transfer.

Since everyone has a fingerprint different from that of the others, the electronic data storage card medium only permits authorized persons to access the data files stored therein, thereby resulting in enhanced security.

While the present invention is depicted in particular as a pen-type peripheral (i.e., USB flash drive) device, it should be appreciated that the present invention is applicable to any and all pocket-sized computer peripheral device types that are readily transportable and which may be advantageously interconnected with various host computer systems. Examples of such portable computer peripheral devices include, but are not limited to, flash memory and other data storage devices, communications devices, scanners and cameras. Terms such as “host computer” and “host system” are used herein to refer to any electronic computer of any type or size including, but not limited to, desktop computers (PC, Mac or other), notebook computers, palmtop computers and personal digital assistant (PDA) devices.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A portable computer peripheral apparatus comprising:
an elongated housing having a wall defining a first opening and an end portion defining an end opening;
at least one electronic device mounted inside of the housing;
a fingerprint sensor movably connected to the housing and electronically connected to said at least one electronic device;
a plug connector movably connected to the housing and electronically connected to said at least one electronic device; and
positioning means for manually moving the fingerprint sensor and the plug connector between a first position, in which the fingerprint sensor is positioned inside of the housing and the plug connector is covered by a portion of the wall, and a second position in which the fingerprint sensor is exposed through the first opening and the plug connector extends through the end opening such that both the fingerprint sensor and the plug connector are exposed outside of the housing.

2. The apparatus of claim 1,
wherein said positioning means comprises a positioning member that is fixedly connected to the plug connector and includes a press-push button,
wherein the housing defines a slot, and
wherein the positioning member is mounted in the housing such that a portion of the press-push button extends through the slot and is exposed outside of the housing.

3. The apparatus of claim 2, wherein the positioning member comprises:
a base portion;
first and second slide rails fixedly connected to the base portion; and
a flexible wall connected to the base portion such that the flexible wall is resiliently bendable relative to the base portion,
wherein the press-push button is disposed on the flexible wall such that when the press-push button is pressed into the housing, the first and second slide rails press against a first inside surface of the housing such that the flexible wall bends into the housing.

4. The apparatus of claim 3,
wherein flexible wall includes a fixed end that is integrally connected to the base portion, and a free end that is disposed away from the base portion, and
wherein the press-push button is disposed on the flexible wall adjacent to the fixed end.

5. The apparatus of claim 3,
wherein the flexible wall includes opposing first and second ends that are integrally connected to the base portion such that standoff gap is defined between a central portion of the flexible wall and the base portion,
wherein the press-push button is disposed on the flexible wall adjacent to the central portion.

6. The apparatus of claim 3,
wherein the positioning member further comprises a locking structure disposed on the flexible wall,
wherein the housing further comprises a second locking structure and a third locking structure, and
wherein the positioning member is mounted in the housing such that the first locking structure engages the second locking structure when the plug connector is in the first position, and such that the first locking structure engages the third locking structure when the plug connector is in the second position.

7. The apparatus of claim 6,
wherein the first locking structure comprises a lock tab protruding from the positioning member, and
wherein the second and third locking structures comprise lock grooves defined on a second inside surface of the housing.

8. The apparatus of claim 7, wherein locking tab is positioned on the flexible wall such that said lock tab is biased away from said positioning slots when said press-push button is pressed into said housing, and such that said lock tab is biased into an associated one of said positioning slots when said press-push button is released.

9. The apparatus of claim 3, wherein the positioning member is mounted in the housing such that the exposed portion of the press-push button is located at a first end of the slot when the plug connector is in the first position, and such that the exposed portion of the press-push button is located at a second end of the slot when the plug connector is in the second position.

10. The apparatus of claim 9,
wherein the plug connector is mounted onto a front edge of a card, wherein the card includes side edges defining cut-outs,
wherein the positioning member comprises connection tabs that are fixedly connected to the base portion and are one of snap-coupled, ultrasonically welded, and thermal adhered onto the card such that each connection tab extends into an associated one of said cut-outs.

11. The apparatus of claim 2, wherein the slot through which the portion of the press-push button extends and the first opening through which the fingerprint sensor is exposed comprise a single opening in the housing.

12. The apparatus of claim 11, wherein the housing comprises a relatively wide upper wall defining said single opening.

13. The apparatus of claim 2, wherein the slot through which the portion of the press-push button extends and the first opening through which the fingerprint sensor is exposed comprise separate, spaced-apart openings in the housing.

14. The apparatus of claim 13, wherein the housing comprises a relatively wide upper wall defining said first opening, and housing defines a relatively narrow side wall defining said slot.

15. The apparatus of claim 1, further comprising a printed circuit board (PCB) movably mounted inside of the housing,
wherein the plug connector is attached to a first end of the PCB, and
wherein the fingerprint sensor and said electronic device are mounted onto one or more surfaces of the PCB.

16. The apparatus of claim 15,
wherein said positioning means comprises a positioning member including a wall defining a sensor opening, and
wherein the positioning member is attached to the PCB such that the wall covers a portion of the PCB and the fingerprint sensor is exposed through the sensor opening.

17. The apparatus of claim 1,
wherein the housing comprises an elongated upper wall, an elongated lower wall, and a pair of elongated side walls extending between the upper and lower walls such that the upper, lower, and side walls form a generally rectangular cross-section, and
wherein the end portion of the housing is located at a first end of the upper, lower, and side walls.

18. The apparatus of claim 17, wherein the housing comprises:
a first portion including the lower wall and a first portion of the side walls; and
a second portion including the upper wall and a second portion of the side walls that is mated to the first portion of the side walls.

19. The apparatus of claim 1, wherein the plug connector comprises a Universal Serial Bus (USB) plug.

20. A portable computer peripheral apparatus comprising:
an elongated housing including a first housing wall defining a slot, a second housing wall disposed opposite to the first housing wall, and an end portion defining an end opening;
a printed circuit board assembly (PCBA) mounted inside of the housing, the PCBA including at least one electronic device and a plug connector that is electronically connected to said at least one electronic device; and
a positioning member including:
a base portion that is fixedly connected to the PCBA;
a flexible wall that is integrally connected to the base portion and disposed adjacent to the first housing wall,
a first locking structure that is fixedly disposed on the flexible wall;
first and second slide rails fixedly connected to the base portion and disposed adjacent to the second housing wall; and
a press-push button that is fixedly disposed on the flexible wall,
wherein the positioning member is movably disposed inside the housing such that a portion of the press-push button extends through the slot and is exposed outside the housing, such that when the press-push button is pressed into said housing, the first and second slide rails contact the second housing wall and the flexible wall is bent from an original shape such that the first locking structure is biased away from the first housing wall, and when said press-push button is subsequently released, the flexible wall resiliently returns to the original shape and the first locking structure is pressed against the first housing wall.

21. The apparatus of claim 20,
wherein flexible wall includes a fixed end that is integrally connected to the base portion, and a free end that is disposed away from the base portion, and
wherein the press-push button is disposed on the flexible wall adjacent to the fixed end.

22. The apparatus of claim 20,
wherein the flexible wall includes opposing first and second ends that are integrally connected to the base portion such that standoff gap is defined between a central portion of the flexible wall and the base portion,
wherein the press-push button is disposed on the flexible wall adjacent to the central portion.

23. The apparatus of claim 20,
wherein the housing further comprises a second locking structure and a third locking structure that are disposed on the first housing wall, and
wherein the positioning member is mounted in the housing such that the first locking structure engages the second locking structure when the plug connector is in the first position, and such that the first locking structure engages the third locking structure when the plug connector is in the second position.

24. The apparatus of claim 23,
wherein the first locking structure comprises a lock tab protruding from the positioning member, and
wherein the second and third locking structures comprise positioning slots defined on a second inside surface of the housing.

25. The apparatus of claim 24, wherein locking tab is positioned on the flexible wall such that said lock tab is biased away from said positioning slots when said press-push button is pressed into said housing, and such that said lock tab is biased into an associated one of said positioning slots when said press-push button is released.

26. The apparatus of claim 20, wherein the plug connector comprises a Universal Serial Bus (USB) plug.
